(19) United States
(12) Patent Application Publication
(10) Pub. No.: US 2022/0087788 A1
(43) Pub. Date: Mar. 24, 2022

(54) DENTAL SCREW

(71) Applicant: BIORL S.R.L., Melzo (Milano) (IT)

(72) Inventor: Redouane SELMOUNE, Bollate (Milano) (IT)

(21) Appl. No.: 17/368,245

(22) Filed: Jul. 6, 2021

(30) Foreign Application Priority Data
Sep. 24, 2020 (IT) 102020000022549

(51) Int. Cl. A61C 8/00; A61C 13/00

(52) U.S. Cl. CPC A61C 8/0074; A61C 13/0019; A61C 8/0012; A61C 8/0071

(57) ABSTRACT

Dental screw which can be inserted into a cavity of a patient's maxillary and/or mandibular bone, including a terminal portion that can be inserted into the cavity so as to fit within it and so as to engage a side wall thereof. The dental screw further includes a cervical portion, configured to engage an artificial tooth structure, and a central portion extending longitudinally between the terminal portion and the cervical portion. The central portion is shaped as a porous structure, particularly as a trabecular structure, to promote an intraosseous regrowth process. The dental screw is further characterised in that the terminal portion, the central portion and the cervical portion are made from a single piece.

This application claims priority to Italian Patent Application 102020000022549 filed Sep. 24, 2020, the entirety of which is incorporated by reference herein.

The present invention relates to a dental screw which is widely used in the field of medical prosthetic implants.

As known, dental screws are inserted into a patient's oral cavity so that an artificial tooth can be fixed.

Known dental screws have a basically cylindrically-shaped main body consisting of three distinct portions which are coupled together by interlocking and mechanical interference.

In greater detail, the main body of the known dental screws has a terminal portion configured to be placed at the bottom of the patient's oral cavity, a central portion shaped to simulate a trabecular bone structure and a cervical portion to which the artificial tooth is screwed. The terminal and cervical portions are both provided with threads configured to engage a side wall of the oral cavity so as to secure the screw within the oral cavity, while the central portion is not.

As known, the portions are joined together by mechanical interference. In particular, the cervical portion is shaped to extend, through the central portion, towards the terminal portion so as to engage the latter and tighten the screw portions together. In this situation, the dental screw is therefore formed by three distinct portions that are assembled together to form a screw main body.

Disadvantageously, known dental screws have drawbacks mainly related to their manufacturing process and to their mechanical properties.

In particular, the portions making up the main body of the screw are manufactured as separate components and then assembled. This aspect generates micro-movements and mechanical clearance between the portions when the screw is inserted and fixed in the oral cavity and/or during the screw daily use. Such micro-movements are detrimental as they can lead to “failure” and/or breakage of the screw itself.

In particular, the connection between the central portion, shaped as a trabecular bone structure, and the remaining portions of the screw is particularly critical and subject to frequent micro-movements. In order to allow assembling properly the dental screw, the central portion is made in such a way as to be particularly thin, which makes the entire portion very fragile and mobile.

A further disadvantage derives from the difficulty in adjusting the pressure exerted by the dental screw on the patient's bone in the cavity. In case of an excessive pressure, bone vascularisation is not allowed and causes problems such as necrosis, by contrast, in case of a too low pressure, the screw is not fixed within the patient's cavity, thus causing the onset of stability problems.

A further disadvantage derives from the fact that known dental screws are usually made of grade 4 titanium, which is lathed, sandblasted, acidified and finally washed and sterilised.

Grade 4 titanium is used because it is sufficiently malleable to obtain a porous structure in the central portion of the screw in order to ease the osseointegration process. However, grade 4 titanium has a low mechanical fatigue strength and therefore tends to accelerate the screw wear process.

A further disadvantage derives from the aforesaid processes which are time-consuming and expensive and generate a significant waste of material, as they are carried out by removal of material.

The technical task of the present invention is to make available a dental screw which is able to overcome the drawbacks of the prior art.

The object of the present invention is therefore to make available a dental screw having excellent mechanical properties in order to ensure a high level of reliability of the screw and a long service life.

A further object of the present invention is to make available a dental screw whose constituent portions, once the screw is positioned in the dental cavity, are not subjected to micro-movements.

A further object of the present invention is therefore to make available a dental screw whose manufacturing process is fast and efficient.

Furthermore, a further object of the present invention is to make available a dental screw having an efficient porosity of the central portion so as to promote an osseointegration process while maintaining excellent mechanical properties.

The specified technical task and the specified objects are substantially achieved by a dental screw comprising the technical characteristics set forth in one or more of the accompanying claims. The dependent claims correspond to possible embodiments of the invention.

In particular, the specified objects are achieved by a dental screw inserted or that can be inserted into a cavity of a patient's maxillary and/or mandibular bone according to the present invention. Such a dental screw comprises a terminal portion inserted or that can be inserted into the cavity so as to be housed therein, preferably so as to rest on a bottom thereof. The terminal portion is also inserted or can be inserted into the cavity so as to engage a side wall. The dental screw also comprises a cervical portion configured to engage an artificial tooth structure. The dental screw object of the present invention further comprises a central portion extending longitudinally between the terminal portion and the cervical portion and shaped as a porous structure, in particular, as a trabecular-type structure, to promote an intraosseous regrowth process. In particular, the terminal portion, the central portion and the cervical portion are made from a single piece.

Advantageously, making the portions constituting the dental screw from a single piece prevents micro-movements between the portions themselves. In particular, making the portions constituting the dental screw from a single piece decreases the wear of the screw itself, reduces the risk of breakage and avoids mechanical clearance and/or interference between the portions which are harmful for the dental screw and uncomfortable for the patient.

Preferably, the aforesaid portions are made by an additive manufacturing technique such as the Direct Melt Laser Sintering technique and Electron Beam Melting technique.

Advantageously, making the dental screw by means of additive technique makes it possible to create a central portion of the screw that is provided with a greater and better porosity than the known techniques. This aspect promotes and speeds up the of osseointegration process.

Advantageously, additive manufacturing techniques make it possible to reduce the production time of dental screws and thus to increase productivity. Additive techniques also make it possible to reduce the associated waste of material by significantly reducing the cost of the dental screw.

Advantageously, making the dental screw by means of an additive technique also makes it possible to use materials which have better mechanical properties than the normally used materials, making the screw stronger and more durable.

Further characteristics and advantages of the present invention will become clearer from the indicative and therefore non-limiting description of an embodiment of a dental screw.

Such description will be set forth herein below with reference to the accompanying drawings, provided for merely indicative and therefore non-limiting purposes, wherein:

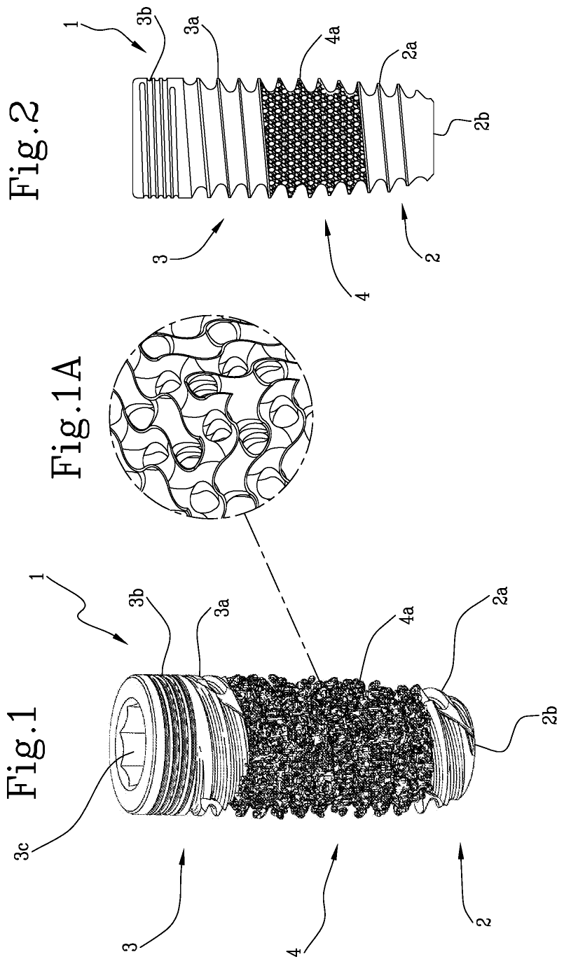

FIG. 1 shows a perspective view of the dental screw that is the object of the present invention;

FIG. 1A shows an enlargement of a detail of the dental screw in FIG. 1; and

FIG. 2 shows a front view of the dental screw object of the present invention.

With reference to the appended figures, 1 denotes a dental screw which can be inserted into a cavity of a patient's maxillary and/or mandibular bone, not shown in the appended figures.

The dental screw 1 comprises a terminal portion 2 which can be inserted into the cavity so as to engage a side wall thereof. In other words, the terminal portion 2 is shaped so as to come into contact with the side wall of the cavity without causing possible damage during insertion.

The dental screw 1 further comprises a cervical portion 3 configured to engage an artificial tooth structure such as a ceramic tooth. Preferably, the cervical portion 3 is recessed into the crestal bone of the patient and, in use, once the dental screw 1 is inserted within the patient's cavity, said cervical portion 3 is arranged so as to be accessible and, therefore, to accommodate the artificial tooth structure in a manner that will be described in detail below.

The dental screw 1 also comprises a central portion 4 extending longitudinally between the terminal portion 2 and the cervical portion 3 and shaped as a porous structure, in particular as a trabecular structure (FIG. 1A), to promote an intraosseous regrowth process.

FIG. 1A shows an embodiment of a possible three-dimensional distribution of the porous structure made according to the present invention for illustrative purposes, however the geometry of the inner “channels” making up the trabecular structure may have geometries that vary depending on design requirements and patient parameters.

Advantageously, the terminal portion 2, the cervical portion 3 and the central portion 4 are made from a single piece.

In other words, the terminal portion 2, the cervical portion 3 and the central portion 4 are made in such a way that the dental screw 1 has a continuous structure, i.e., a structure in which there is no mechanical interference, interlocking, form-fitting, welding and the like between the portions 2, 3, 4.

The fact that the dental screw is made 1 from a single piece makes it particularly strong in terms of mechanical properties and more durable in terms of service life. In known dental screws, the point where the central porous portion engages with the other two respective portions of the dental screw is a particularly critical point due to the porous structure and it is therefore more likely to break. In the case of the present invention, however, this drawback is substantially eliminated since portions 2, 3, 4 define a single body.

In other words, the fact of making the portions 2, 3, 4 composing the dental screw 1 from a single piece avoids having to assemble the portions 2, 3, 4 together by means of engagement and mechanical connections that may result in breakage and/or damage of the dental screw 1 due to the micro-movements reported in the known art.

Preferably, an additive manufacturing technique such as the Direct Melt Laser Sintering technique or the Electron Beam Melting technique is used to make portions 2, 3, 4 of the dental screw 1.

Such a technique also makes it possible to significantly reduce the time required to make the dental screw 1, thereby increasing the production rate.

The additive manufacturing technique, which works by adding material, also makes it possible to reduce the amount of material waste resulting from the processing itself, thus reducing the costs involved in making the dental screw 1.

Advantageously, the additive manufacturing technique also makes it possible to obtain a central portion 4 structure having a high degree of porosity. Such as aspect is particularly advantageous as it promotes and speeds up intraosseous tissue growth.

In the preferred embodiment, the central portion 4 of the dental screw 1, as well as the terminal portion 2 and the cervical portion 3, is made of a titanium, aluminium and vanadium alloy (Ti₆Al₄V).

Advantageously, this alloy, which is widely used in the orthopaedic sector, has mechanical properties that are far better than those of the titanium alloy, which is typically used for dental screws.

The possibility of creating a central portion 4 that is highly porous, and therefore as similar as possible to a real trabecular structure, also allows to better fix the dental screw 1 within the cavity.

Referring now to the enclosed figures, a detailed description of the portions 2, 3, 4 constituting the dental screw 1 that is the object of the present invention is provided.

As shown in FIG. 1, the terminal portion 2 comprises a side surface provided with a self-tapping thread 2a and a base surface 2b. The thread 2a allows the screw 1 to be screwed into the patient's cavity in such a way as to promote fixation of the dental screw 1 at a predetermined position in the cavity.

As visible from FIG. 2, the central portion 4 has a side surface at least partially provided with a self-tapping thread 4a configured to engage the side wall of the patient's cavity.

In detail, this self-tapping thread 4a also has a porous structure, in particular a trabecular structure.

Preferably, the self-tapping thread 4a placed on the central portion 4 has a pitch between 1.2 mm and 3.5 mm.

In other words, when the dental screw 1 is manufactured, the central portion 4 is made as a volume having a porous structure and provided, on a side surface, with a self-tapping thread 4a also having a porous structure.

This is a particularly advantageous aspect in that the self-tapping thread 4a obtained on the central portion 4 enables the dental screw 1, once positioned in the oral cavity, to firmly maintain this position.

This self-tapping thread 4a also makes the central portion 4 stronger and more robust and allows to apply a correct clamping pressure in the patient's cavity. In fact, by making a thread 4a also on the central portion 4 of the dental screw 1, it is possible to exert the correct pressure on the patient's cavity avoiding problems of bone necrosis and/or undesired movement of the dental screw 1 within the cavity.

In a preferred embodiment, the self-tapping thread 4a is the extension of the self-tapping thread 2a. As will be described hereinafter in detail, the cervical portion 3 is provided with a self-tapping thread 3a which is the extension of the self-tapping thread 4a of the central portion 4.

In other words, the self-tapping threads 2a, 3a and 4a constitute portions of a single self-tapping thread extending between the terminal portion 2 and the cervical portion 3.

Advantageously, thus, the self-tapping threads 2a, 3a, 4a define a single self-tapping thread which extends continuously around the terminal portion 2, the central portion 4 and the cervical portion 3.

Advantageously, a single thread prevents the dental screw 1 from undergoing micro-movements once installed in the patient's oral cavity.

In a preferred embodiment, the self-tapping threads 2a, 3a, 4a have the same pitch.

In a further possible embodiment, not shown, the self-tapping threads 2a, 3a, 4a have different pitches despite being portions of a single self-tapping thread.

Still referring to FIG. 1, there is shown the cervical portion 3 whose side surface comprises, in a position proximal to the central portion 4, the aforementioned self-tapping thread 3a configured to engage a wall of the patient's cavity. The cervical portion 3 also includes a secondary thread 3b in order to obtain a roughness near the patient's crestal bone.

Preferably the single self-tapping thread extends between the secondary thread 3b and the base surface 2b.

Preferably, the cervical portion 3 further comprises a shaped seat 3c configured to accommodate a tool for installing the dental screw 1 in the cavity.

Still more preferably, such shaped seat 3c has an octagonal conometric cross-section.

Said shaped seat 3c may further be configured to accommodate, after the dental screw 1 is placed in the cavity, a connection portion of the artificial dental structure so that the latter is constrained to the dental screw 1. In such a situation, the shaped seat 3c is, for example, made in such a way that the artificial tooth structure cannot perform any rotational movement around a longitudinal axis of the dental screw 1 itself, thus keeping the artificial tooth locked in position. The shaped seat 3c can also accommodate healing screws, MUAs and/or test posts for taking a dental impression.

According to a further aspect of the present invention, the dental screw 1 has a basically circular cross-section and a shape that tapers from the cervical portion 3 to the terminal portion 2.

In a further possible embodiment, not shown, the dental screw 1 has a substantially cylindrical shape.

The present invention achieves the intended purposes overcoming the drawbacks of the prior art.

In particular, the dental screw 1 is not subject to problems deriving from micro-movements due to the mechanical interferences between the portions 2, 3, 4 being the latter made from a single piece so that the dental screw 1 has a continuous structure.

As the dental screw 1 object of the present invention is made by means of an additive manufacturing technique, it allows the terminal portion 2, the central portion 4 and the cervical portion 3 to be made from a single piece and to be interconnected without interference and mechanical clearance.

Advantageously, the dental screw 1 thus has a continuous structure which is made layer by layer according to an additive technique which is typical of additive manufacturing.

The dental screw 1 is less subject to wear and break than the known screws made by assembling several portions.

The dental screw 1 is manufactured more quickly than the known art screws and is more cost-efficient as well.

By virtue of its central structure which is particularly similar to a real trabecular structure, the dental screw 1 object of the present invention, promotes and optimises the osseointegration process.

The dental screw 1 has better mechanical properties than the screws of the prior art.

The presence of the self-tapping thread 4a on the central portion of the dental screw 1 encourages to maintain the correct position of the screw 1 within the patient's oral cavity during the osseointegration process and allows the dental screw 1 to exert the correct pressure within the patient's cavity preventing the risk of necrosis, micro-movements and breakage of the trabecular porous structure from occurring.

1. A dental screw, which can be inserted into a cavity of a patient's maxillary and/or mandibular bone, comprising:
a terminal portion that can be inserted into said cavity so as to engage a side wall thereof;
a cervical portion configured to engage an artificial tooth structure;
a central portion extending longitudinally between said terminal portion and said cervical portion and shaped as a porous structure, in particular as a trabecular structure, to promote intraosseous regrowth;
wherein said terminal portion, said central portion, and said cervical portion are made from a single piece.

2. The screw according to claim 1, wherein said screw is made using an additive manufacturing technique.

3. The screw according to claim 1, wherein said central portion has a side surface at least partially equipped with a self-tapping thread configured to engage the side wall of said cavity.

4. The screw according to claim 3, wherein said self-tapping thread has a porous structure, in particular a trabecular structure.

5. The screw according to claim 3, wherein said terminal portion and said cervical portion have self-tapping threads at their corresponding side surfaces that are configured to engage the side wall of said cavity, wherein said self-tapping threads are connected together in order to define a single self-tapping thread extending between said terminal portion and said cervical portion.

6. The screw according to claim 1, wherein said cervical portion comprises a secondary screw thread.

7. The screw according to claim 1, wherein said cervical portion comprises a shaped seat configured to accommodate a tool for installing said screw in the cavity and/or to accommodate a connection portion of said artificial tooth structure, said shaped seat preferably has an octagonal conometric cross-section.

8. The screw according to claim 1, wherein said dental screw is made of a titanium-vanadium-aluminium alloy (Ti₆Al₄V).

9. The screw according to claim 1, wherein said dental screw has a basically circular cross-section and a shape that tapers from said cervical portion to said terminal portion.
